(19) United States
(12) Patent Application Publication
(10) Pub. No.: US 2020/0184584 A1
(43) Pub. Date: Jun. 11, 2020

(54) SYSTEMS AND METHODS FOR LEGAL CLAUSE MATCHING AND EXPLANATION

(71) Applicant: Capital One Services, LLC, McLean, VA (US)

(72) Inventors: Reza FARIVAR, McLean, VA (US); Jeremy Edward GOODSITT, McLean, VA (US); Fardin Abdi Taghi ABAD, Seattle, WA (US); Anh TRUONG, McLean, VA (US); Kenneth TAYLOR, Champaign, IL (US); Mark WATSON, Urbana, IL (US); Vincent PHAM, McLean, VA (US); Austin WALTERS, McLean, VA (US)

(21) Appl. No.: 16/506,229

(22) Filed: Jul. 9, 2019

Related U.S. Application Data
(60) Provisional application No. 62/776,970, filed on Dec. 7, 2018.

(51) Int. Cl. G06Q 50/18; G06N 3/04; G06N 3/08; G06K 9/62

(52) U.S. Cl. CPC G06Q 50/18; G06N 3/04; G06K 9/6297; G06K 9/6215; G06N 3/08

(57) ABSTRACT

A tool configured to cause the system to perform steps of a method is presented. The method includes receiving labeled training data comprising a labeled set of caselaw. The method further includes training a recurrent neural network model using the labeled training data to generate logical rules, wherein the logical rules comprise rules relating legal clauses from the labeled set of caselaw to outcomes from the labeled set of caselaw. The method includes applying the recurrent network model to a corpus of caselaw to generate a first set logical rules. The method includes receiving a first legal document comprising one or more legal clauses and applying the recurrent network model to the first legal document to generate a second set of logical rules. Based on a comparison of the first set of logical rules with the second set of logical rules, determining a relevant case from the corpus of caselaw.

### CROSS REFERENCE TO RELATED APPLICATIONS AND PRIORITY CLAIM

This application is a non-provisional of, and claims priority under 35 U.S.C. § 119(e) to, U.S. Provisional Patent Application No. 62/776,970, filed Dec. 7, 2018, of the same title, the entire contents of which are hereby incorporated by reference as if fully set forth below.

### FIELD OF INVENTION

The present disclosure relates to systems and methods for matching legal clauses from various types of legal documents and providing explanation based on clause matching, and more particularly to systems and methods using a trained neural network (NN) to identify and translate legal clauses into sets of rules that can be used to match legal clauses from various types of legal documents and provide explanation based on clause matching.

### BACKGROUND

Legal documents tend to be difficult to read and understand, often due to the presence archaic “legalese” jargon or terms. As a result, it can be hard for involved parties to understand the implications of various terms or clauses included in their documents or agreements. Further, even lawyers who draft such legal documents may have difficulties in understanding and/or forecasting the future effects of such clauses. This analysis is even further complicated by the fact that legal specific terms or clauses could have different implications depending on the location (e.g., jurisdiction) in which they are used. Even for those who can understand complex legal documents, analyzing the documents can take considerable time and, in turn, expense.

Accordingly, there is a need for systems and methods for translating legal clauses into a set of rules that can be used to match legal clauses from various types of legal documents and provide explanation based on clause matching. Embodiments of the present disclosure are directed to this and other considerations.

### SUMMARY

Disclosed embodiments provide systems and methods using an NN for translating legal clauses into a set of rules that can be used to match legal clauses from various types of legal documents and provide explanation based on clause matching.

Consistent with the disclosed embodiments, various methods and systems are disclosed. In an embodiment, a method for translating legal clauses into a set of rules that can be used to match legal clauses from various types of legal documents and provide explanation based on clause matching is disclosed. The method may be implemented with a computing device. The method may include receiving labeled training data comprising a set of caselaw having labeled legal clauses and corresponding labeled outcomes. Next, the method may include training, using the labeled training data, a recurrent neural network for identify legal clauses and outcomes from a set of caselaw and to generate logical rules for associating the legal clauses to the outcomes. Further the method may include applying the recurrent network model to a corpus of caselaw to generate a first set logical rules associated with the corpus of caselaw. The method may also include receiving a first legal document comprising one or more legal clauses. The method may then include applying the recurrent network model to the first legal document to generate a second set of logical rules associated with the first legal document. Based on a comparison of the first set of logical rules with the second set of logical rules, the method may include determining a relevant case from the corpus of caselaw. Finally, the method may include transmitting data representing the relevant case from the corpus of caselaw.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example system environment that may be used to implement one or more embodiments of the present disclosure;

FIG. 2 is a component diagram of a service provider system according to an example embodiment; and

FIGS. 3-5 are flowcharts of methods for matching legal clauses from various types of legal documents and providing explanation based on legal clause matching according to an example embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, the term “legalese” refers to the specialized language of the legal profession. The goal of this disclosure is to translate legal clauses into a set of rules that can be used to match legal clauses from various types of legal documents and provide explanation based on clause matching.

The present disclosure is directed to methods and systems for using NN, and, in particular, for utilizing a recurrent neural network (RNN) to translate legal clauses into a set of rules that can be used to match legal clauses from various types of legal documents (e.g., assignment of interests, non-disclosure agreements, employment contracts, terms of service agreements). The legal documents may be provided to the RNN, which then generates a set of logical rules related to the legal documents. The system may then compare the generated logical rules in order to determine similar legal documents. Based on this comparison, the system may determine specific caselaw that is relevant to the provided legal documents.

Reference will now be made in detail to example embodiments of the disclosed technology, examples of which are illustrated in the accompanying drawings and disclosed herein. Wherever convenient, the same references numbers will be used throughout the drawings to refer to the same or like parts.

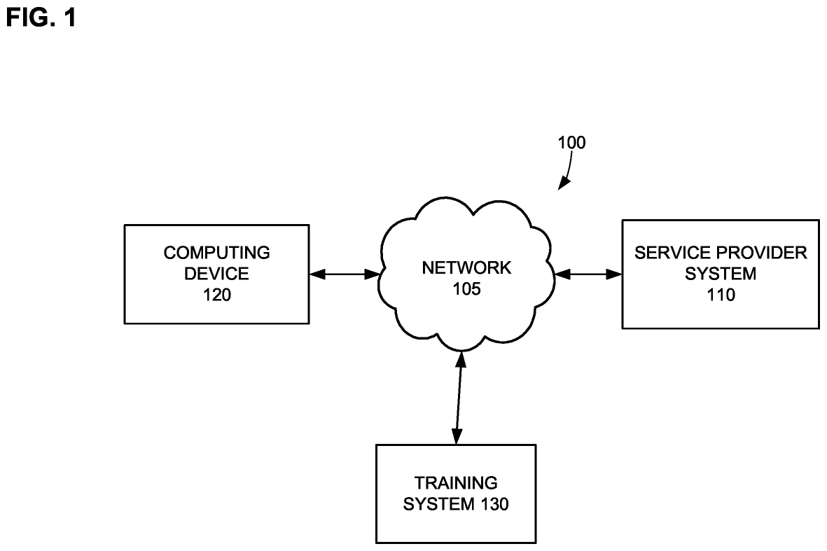

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary.

In accordance with disclosed embodiments, system 100 may include a service provider system 110 in communication with a computing device 120 via network 105. In some embodiments, service provider system 110 may also be in communication with various databases. Computing device 120 may be a mobile computing device (e.g., a smart phone, tablet computer, smart wearable device, portable laptop computer, voice command device, wearable augmented reality device, or other mobile computing device) or a stationary device (e.g., desktop computer).

In some embodiments, the computing device 120 may transmit a legal document consisting of legal clauses to the service provider system 110, and the service provider system 110 may utilize a trained NN to translate the legal document into a series of logical rules or data modules. In some example embodiments, the NN may comprise multiple NNs to be used for different stages of the model. In some example embodiments, the NN may comprise recurrent neural networks (RNNs), convolutional neural networks (CNNs), some combination of both, or any other suitable machine learning technique. In some embodiments, the server provider system 110 may control the computing device 120 to implement one or more aspects of the NN. According to some embodiments, the computing device 120 may perform pre-processing on the legal clause (or legal document) before sending pre-processed legal clause (or legal document) to the service provider system 110.

In some embodiments, the training system 130 may be a system (e.g., a computer system) configured to transmit and receive information associated with training a NN model, such as training data. According to some embodiments, the training data may be labeled training data. For example, in some example embodiments consistent with the present disclosure, the training data may include caselaw that has been labeled or formatted in such a way that it can serve as input to the NN model. The training system 130 may include one or more components that perform processes consistent with the disclosed embodiments. For example, the training system 130 may include one or more computers (e.g., servers, database systems, etc.) that are configured to execute software instructions programmed to perform aspects of the disclosed embodiments.

Network 105 may be of any suitable type, including individual connections via the internet such as cellular or WiFi networks. In some embodiments, network 105 may connect systems using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

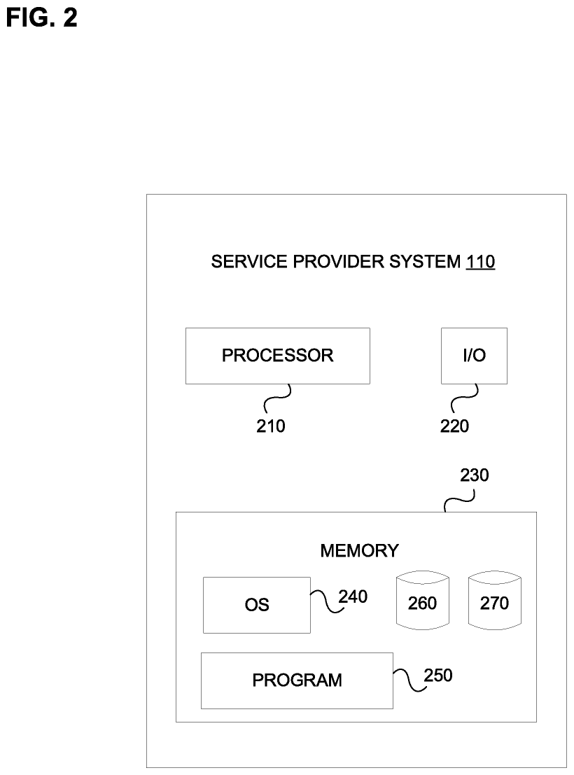

An example embodiment of service provider system 110 is shown in more detail in FIG. 2. The training system 130 and the computing device 120 all may have a similar structure and components that are similar to those described with respect to the service provider system system 110. As shown in FIG. 2, service provider system 110 may include a processor 210, an input/output (“I/O”) device 220, a memory 230 containing an operating system (“OS”) 240 and a program 250. For example, service provider system 110 may be a single server or may be configured as a distributed computer system including multiple servers or computers that interoperate to perform one or more of the processes and functionalities associated with the disclosed embodiments. In some embodiments, service provider system 110 may further include a peripheral interface, a transceiver, a mobile network interface in communication with processor 210, a bus configured to facilitate communication between the various components of the service provider system 110, and a power source configured to power one or more components of service provider system 110.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 210 to communicate with other devices via wired or wireless networks, whether local or wide area, private or public, as known in the art. A power source may be configured to provide an appropriate alternating current (AC) or direct current (DC) to power components.

As described above, service provider system 110 may configured to remotely communicate with one or more other devices, such as computer device 120. According to some embodiments, service provider system 110 may utilize an NN model to translate legal clauses into a set of rules that can be used to match legal clauses from various types of legal documents and provide explanation based on clause matching.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Service provider system 110 may include one or more storage devices configured to store information used by processor 210 (or other components) to perform certain functions related to the disclosed embodiments. In one example, service provider system 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, service provider system 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, service provider system 110 may include memory 230 that may include one or more programs 250 to perform one or more functions of the disclosed embodiments. Moreover, processor 210 may execute one or more programs 250 located remotely from service provider system 110. For example, service provider system 110 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include an image processing database 260 and a neural-network pipeline database 270 for storing related data to enable service provider system 110 to perform one or more of the processes and functionalities associated with the disclosed embodiments.

Service provider system 110 may also be communicatively connected to one or more memory devices (e.g., databases (not shown)) locally or through a network. The remote memory devices may be configured to store information and may be accessed and/or managed by service provider system 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Service provider system 110 may also include one or more I/O devices 220 that may include one or more interfaces for receiving signals or input from devices and providing signals or output to one or more devices that allow data to be received and/or transmitted by service provider system 110. For example, service provider system 110 may include interface components, which may provide interfaces to one or more input devices, such as one or more keyboards, mouse devices, touch screens, track pads, trackballs, scroll wheels, digital cameras, microphones, sensors, and the like, that enable service provider system 110 to receive data from one or more users (such as via computing device 120).

In example embodiments of the disclosed technology, service provider system 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While service provider system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the system 110 may include a greater or lesser number of components than those illustrated.

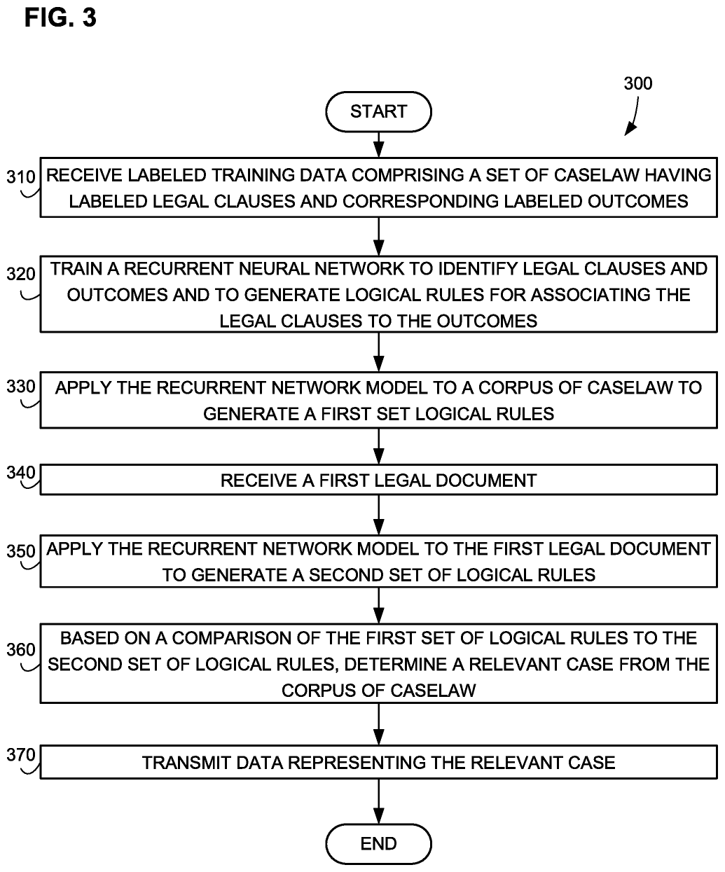

FIG. 3 shows a flowchart of a method 300 for translating legal clauses into a set of rules that can be used to match legal clauses from various types of legal documents and provide explanation based on clause matching. Method 300 may be performed by the service provider system 110, the computing device 120, the training system 130, or by some combination of the said devices.

In block 310, a system may receive, receive, from a training system, labeled training data comprising a set of caselaw having labeled legal clauses and corresponding labeled outcomes. In some embodiments, case law may be converted into data structures such as for example, resource description framework (RDF) triple, vectors, matrices, hierarchical tree structure around related topics, or other similar data structures. According to some example embodiments, the labeled training data may further comprise a set of legal documents associated with the set of caselaw, the set of legal documents having labeled legal clauses and corresponding labeled outcomes. As an example, the set of case law may include final rulings issued by a court, filings by parties to a case, underlying documents related to a case, or any other relevant legal document. For example, in a case involving a contractual dispute, the set of case law may include the filed complaint(s), the filed answer(s), the contract at issue in the case, the final ruling, briefs, responses, or rulings on any other issues introduced during litigation, discovery documents, or any other legal document relevant to the underlying case.

In some example implementations, the set of caselaw may include labels indicating the presence of a legal clause within the individual case documents or opinions. For example, in an embodiment where the caselaw relates to a contract dispute, the final opinion may have a label indicating that an indemnification clause of the underlying contract was discussed in the opinion. The caselaw may further include labels indicating the presence of a legal outcome within the individual case documents or opinions. For example, in a contract case, the court's opinion may include a label indicating that the underlying contract is valid, invalid, or some combination depending on the court's ultimate finding.

In block 320, the system may train, using the labeled training data, a recurrent neural network, or RNN, to identify legal clauses and outcomes from a set of caselaw and to generate logical rules for associating the legal clauses to the outcomes. For example, in an embodiment where the set of caselaw relates to contract cases, the RNN may generate a logical rule indicating that when a binding arbitration clause is present, the contract is not considered valid. As another example, in an embodiment where the set of caselaw relates to employment contracts cases, the RNN may generate a logical rule indicating that when an assignment of rights clause utilizes future tense language (e.g., agrees to assign, will assign, etc.) the rights have not been assigned upon execution of the contract. In some implementations, the logical rules generated by the RNN may be tied to a specific jurisdiction.

In block 330, the system may apply the recurrent network model to a corpus of caselaw to generate a first set logical rules associated with the corpus of caselaw. The method may further include the step of identifying a legal clause in each document of the received corpus of caselaw. The step of identifying may be performed by an RNN using long short-term memory (LSTM) units and/or a convolutional neural network (CNN). In some embodiments, the RNN may generate a first set of logical rules by summarizing the text in each document of the received corpus of caselaw. In some implementations, the RNN may index the summarized text. As will be appreciated, such indexing allows should decrease the time needed to search the summarized text.

In some example implementations, the RNN may utilize one or more word embedding models to vectorize the text of a legal document. Such an example presents the benefit of allowing for easier comparison of such documents. Further, as will be appreciated, a corpus of legal documents may contain both legally relevant (e.g., contract documents, case opinions, etc.) and non-legally relevant (e.g., scheduling orders, credentials of expert witnesses, etc.) material. According to some embodiments, the RNN may be trained to classify the text of a document based on the distribution of the words used, their frequency, or any other relevant metric in order to identify whether or not the document is legally relevant.

In block 340, the system may receive, from a computing device, a first legal document comprising one or more legal clauses. According to some embodiments, the service provider system 110 receives one or more legal clauses or an entire legal document. In other embodiments, the legal clause is received and then recognized as a legal clause rather than a non-legal clause (e.g., a clause from a technical report). In some embodiments, the method may include receiving a document rather than receiving a legal clause. As will be appreciated, a corpus document of text may contain both legally relevant (e.g., contract classes) and non-legally relevant (e.g., name of counsel for party) material. According to some embodiments, the RNN may be trained to classify the text based on the distribution of the words used, their frequency, or any other relevant metric in order to identify if the clause is a legal clause.

In block 350, the system may apply the recurrent network model to the first legal document to generate a second set of logical rules associated with the first legal document. According to some embodiments the legal document may comprise one or more legal clauses and the legal rules may associate the legal clauses with one or more outcomes of interest. As will be understood by one of ordinary skill, applying the recurrent network model to the first legal may be substantially similar to the corresponding elements discussed above with reference to FIG. 3 (e.g., blocks 320-330).

In block 360, based on a comparison of the first set of logical rules with the second set of logical rules, the system may determine a relevant case from the corpus of caselaw. According to some embodiments, the comparison may comprise determining a level of similarity between legal clauses found in the legal document and legal clauses found in a specific case from the corpus of caselaw.

In block 370, the system may transmit, to the computing device, data representing the relevant case from the corpus of caselaw. In some embodiments, the system may first retrieve the relevant case data from a third party. According to some embodiments, system may annotate the relevant case to highlight one or more legal clauses associated with the first or second set of logical rules in a first color. In such an embodiment, the system may then transmit the annotated case to the computing device. In some example implementations, the system may further annotate the relevant case to highlight one or more outcome associated with the relevant case in a second color. In some cases, the first color and the second color are the same color. In other cases, the first color and the second color are not the same color.

In some example embodiments, the service provider system 110 may be further configured to receive, from the computing device, reinforcement feedback based on the relevant case from the corpus of caselaw. The system may then iteratively re-train the recurrent neural network based on the received reinforcement feedback. For example, the system may present the user with an option to provide a score indicative of the relevance or usefulness of the provided case. Responsive to receiving the user's input, the system may utilize the scored case as labeled training data to iteratively re-train the model.

According to some example embodiments, the service provider system 110 may be further configured to determine, based on the legal document, a relevant jurisdiction. For example, if the legal document is a contract, the system 110 may determine, based on one or more contractual provision, that the contract is controlled by Georgia law. In such an embodiment, the system 110 may determine that the relevant jurisdiction is geographically constrained to Georgia state courts. In another embodiment, the system 110 may determine that the relevant jurisdiction is the 11^{th} circuit and all subservient district courts. In some embodiments, the system 110 may be further configured to generate a jurisdiction specific corpus of caselaw comprising caselaw from the relevant jurisdiction. The system may be further configured to apply the recurrent network model to the jurisdiction specific corpus of caselaw to generate a first set logical rules associated with the corpus of caselaw.

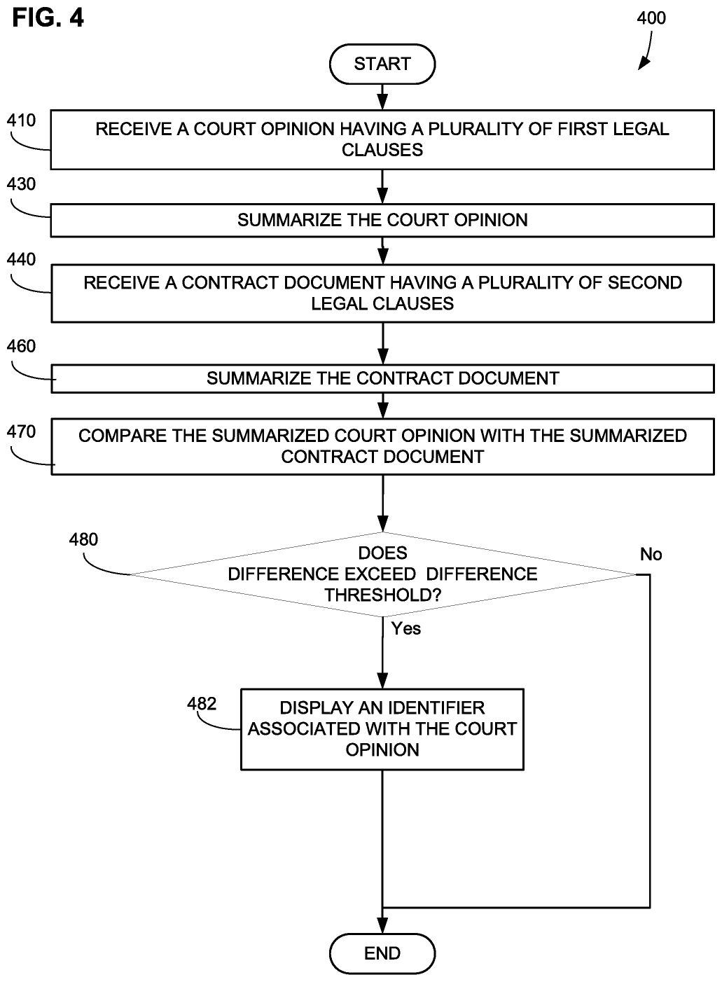

FIG. 4 shows a flowchart of a method 400 for comparing translating legal clauses into a set of rules that can be used to match legal clauses from various types of legal documents and provide explanation based on clause matching. Method 400 may be performed by one or more of the service provider system 110 and the computing device 120 of the system 100.

In block 410 of method 400 in FIG. 4, the system may receive a court opinion having a plurality of legal clauses. As will be understood by one of ordinary skill, receiving a court opinion having a plurality of legal clauses may be substantially similar to the corresponding elements discussed above with reference to FIG. 3 (e.g., block 340).

In block 420, the system may generate, using a segmentation algorithm, a first Markov chain including a plurality of first nodes based on the court opinion, the plurality of first nodes each corresponding to one or more of the plurality of legal clauses of the court. The first Markov chain may also include one or more arrows associated with one or more nodes. For example, a first first node of the plurality of first nodes may include an arrow connecting to a second first node of the plurality of first nodes.

In block 430, the system may summarize the plurality of first nodes. As will be understood by one of ordinary skill, summarizing the plurality of first nodes may be substantially similar to the summarizing portions of text documents discussed above with reference to FIG. 3 (e.g., block 330).

In block 440, the system may receive a contract document having a plurality of second legal clauses. As will be understood by one of ordinary skill, receiving a contract document having a plurality of legal clauses may be substantially similar to the corresponding elements discussed above with reference to FIG. 3 (e.g., block 340).

In block 450, the system may generate, using the segmentation algorithm, a second Markov chain including a plurality of second nodes based on the contract document. The plurality of second nodes each corresponding to one or more of the plurality of second legal clauses of the contract document. The second Markov chain may also include one or more arrows associated with one or more nodes. For example, a first second node of the plurality of second nodes may include an arrow connecting to a second second node of the plurality of second nodes.

In block 460, the system may summarize the plurality of second nodes. As will be understood by one of ordinary skill, summarizing the plurality of second nodes may be substantially similar to the summarizing portions of text documents discussed above with reference to FIG. 3 (e.g., block 330).

In block 470, the system may compare each of the summarized plurality of first nodes with each of the summarized plurality of second nodes to identify a difference for each of the plurality of first nodes. In an embodiment, the comparison may include fuzzy matching the summarized plurality of first nodes with the summarized plurality of second nodes. Fuzzy matching may help identify whether nodes are similar and not necessarily find exact matches between two nodes of different legal clauses. In an embodiment, the comparison may include determining a Levenshtein distance between the summarized plurality of first nodes and the summarized plurality of second nodes. In an embodiment, the comparison may involve the use of a deep learning model or an NN.

In block 480, the system may determine, based on the comparison, whether the difference for each of the plurality of first nodes exceeds a predetermined minimum difference threshold. For example, the system may determine whether the Levenshtein distance between two particular nodes exceed a predetermined minimum difference threshold. When the difference exceeds the predetermined minimum difference threshold, the system moves to block 482.

In block 482 of method 400, the system may display an identifier associated with the court opinion. For example, the system may display the case citation information. In some example implementations, the system may display all or a portion of the case text.

In some example embodiments, the service provider system 110 may be further configured to receive, from the computing device, reinforcement feedback based on the relevant case from the corpus of caselaw. The system may then iteratively re-train the recurrent neural network based on the received reinforcement feedback. For example, the system may present the user with an option to provide a score indicative of the relevance or usefulness of the provided case. Responsive to receiving the user's input, the system may utilize the scored case as labeled training data to iteratively re-train the model.

According to some example embodiments, the service provider system 110 may be further configured to determine, based on the legal document, a relevant jurisdiction. For example, if the legal document is a contract, the system 110 may determine, based on one or more contractual provision, that the contract is controlled by Georgia law. In such an embodiment, the system 110 may determine that the relevant jurisdiction is geographically constrained to Georgia state courts. In another embodiment, the system 110 may determine that the relevant jurisdiction is the 11^{th} circuit and all subservient district courts. In some embodiments, the system 110 may be further configured to generate a jurisdiction specific corpus of caselaw comprising caselaw from the relevant jurisdiction. The system may be further configured to apply the recurrent network model to the jurisdiction specific corpus of caselaw to generate a first set logical rules associated with the corpus of caselaw.

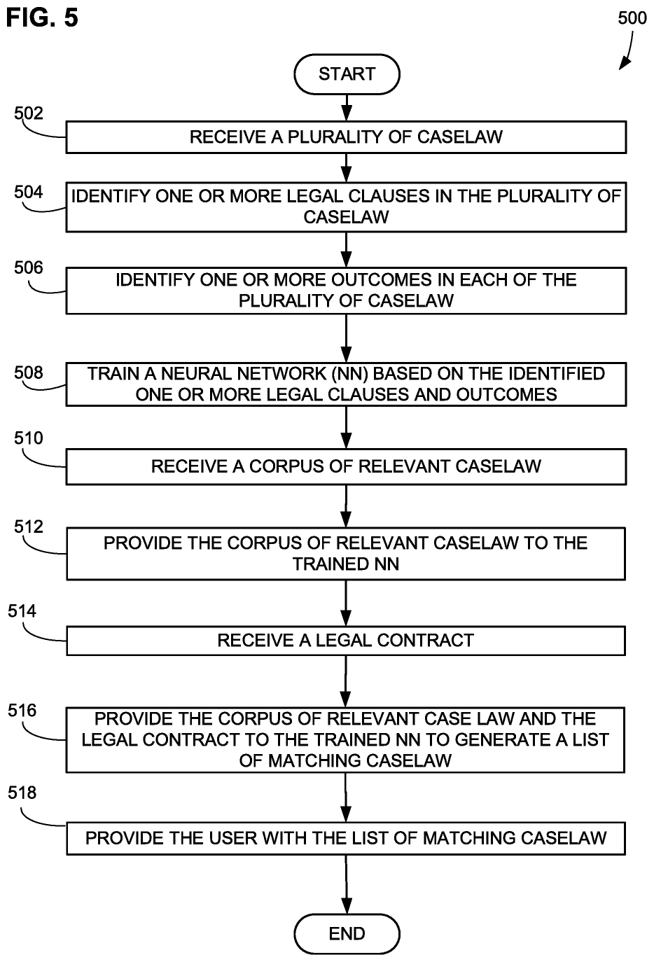

FIG. 5 is a flowchart of a method 500 for comparing translating legal clauses into a set of rules that can be used to match legal clauses from various types of legal documents and provide explanation based on clause matching. Methods 500 may be performed by one or more of the service provider system 110 and the computing device 120 of the system 100.

In block 502, the system may receive a plurality of caselaw. The plurality of caselaw may be judicial opinions issued as part of the record of litigation. The caselaw may include attachments of other legal documents such as a contracts, nondisclosure agreement, a draft patent application, an assignment, an employment agreement, etc.

In block 504, the system may identify one or more legal clause in the plurality of caselaw. As discussed above, the plurality of attorney communications may be judicial opinions issued as part of the record of litigation.

In block 506, the system may identify one or more outcome in each of the plurality of caselaw. As discussed above, the plurality of attorney communications may be judicial opinions issued as part of the record of litigation.

In block 508, the system may train a NN based on the identified one or more legal clause and the identified outcomes. For example, the system may feed the identified one or more legal clauses along outcomes of the one or more cases to the NN. As discussed previously the neural network may be an RNN, a CNN, or an RCNN.

In block 510, the system may receive a corpus of relevant caselaw. According to some embodiments, the service provider system 110 receives one or more legal clauses or an entire legal document. In other embodiments, the legal clause is received and then recognized as a legal clause suitable for translation into a logical rule. The method may further include the step of identifying a legal clause in the received document. The step of identifying may be performed by an RNN using long short-term memory (LSTM) units or a CNN.

In block 512, the system may provide the corpus of relevant caselaw to the trained NN. For example, in some embodiments, the corpus of relevant caselaw may be limited to a certain type of case (e.g., contract, divorce, custody, tort, etc.). In some implementations, the corpus of relevant caselaw may be limited to a certain jurisdiction (e.g., Virginia cases, federal court, supreme court cases, etc.) As will be appreciated, the corpus of relevant caselaw can be limited based on any legally significant factor that is of interest to a user of the system.

In block 514, the system may receive a legal contract. According to some embodiments, the service provider system 110 receives one or more legal clauses or an entire legal document. In other embodiments, the legal clause is received and then recognized as a legal clause suitable for translation into a logical rule. The method may further include the step of identifying a legal clause in the received document. The step of identifying may be performed by an RNN using long short-term memory (LSTM) units or a CNN.

In block 516, the system may provide the corpus of relevant caselaw and the legal contract to the trained recurrent neural network to generate a list of matching caselaw comprising one or more case from the corpus of relevant caselaw. As will be understood by one of ordinary skill, generate a list of matching caselaw may be substantially similar to corresponding elements discussed above with reference to FIG. 3 (e.g., block 330-360).

In block 518, the system may provide to the user, the list of matching caselaw. As will be understood by one of ordinary skill, providing the list of matching caselaw may be substantially similar to corresponding elements discussed above with reference to FIG. 3 (e.g., block 370).

In some example embodiments, the service provider system 110 may be further configured to receive, from the computing device, reinforcement feedback based on the relevant case from the corpus of caselaw. The system may then iteratively re-train the recurrent neural network based on the received reinforcement feedback. For example, the system may present the user with an option to provide a score indicative of the relevance or usefulness of the provided case. Responsive to receiving the user's input, the system may utilize the scored case as labeled training data to iteratively re-train the model.

According to some example embodiments, the service provider system 110 may be further configured to determine, based on the legal document, a relevant jurisdiction. For example, if the legal document is a contract, the system 110 may determine, based on one or more contractual provision, that the contract is controlled by Georgia law. In such an embodiment, the system 110 may determine that the relevant jurisdiction is geographically constrained to Georgia state courts. In another embodiment, the system 110 may determine that the relevant jurisdiction is the 11^{th} circuit and all subservient district courts. In some embodiments, the system 110 may be further configured to generate a jurisdiction specific corpus of caselaw comprising caselaw from the relevant jurisdiction. The system may be further configured to apply the recurrent network model to the jurisdiction specific corpus of caselaw to generate a first set logical rules associated with the corpus of caselaw.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Case

The following example use case describes an example of a typical use of translating legal clauses into a set of rules that can be used to match legal clauses from various types of legal documents and provide explanation based on clause matching. It is intended solely for explanatory purposes and not in limitation. In one case, a user may be drafting or may receive an electronic version of a legal document for execution via email on their portable laptop computer (e.g., computing device 120). In some cases, the user may have a hard copy of a legal document that they may digitize in some manner (e.g., scanning, taking a picture, etc.). Once the user as the legal document in digital form, the user may upload the digital version of the legal document to a portal associated with a system (e.g., service provider system 110). The system may then identify one or more legal clauses (e.g., contract provisions) within the legal document and may generate a set of logical rules based on the one or more legal clauses. As an example, a contract (e.g., legal document) may have an arbitration provision (e.g., legal clause) that reads “any arbitration for this contract would solely take place at a court at the discretion of the service provider.” In such an example, the system may generate a rule indicating that the arbitration clause is weighted towards the service provider. As another example, a divorce agreement (e.g., legal document) may have a clause discussing custody of a pet (e.g., legal clause). In such an example, the system may generate a rule that indicates a certain outcome with regards to pet agreements in divorce agreements (e.g., the clauses are enforceable or not). The system may then compare the rule to a set of rules based on relevant case law (e.g., same jurisdiction as contract is to be executed, based on contract law, etc.). Based on this comparison, the system may identify cases that will be relevant to the legal document such that the aid in understanding the meaning of the legal clause and the potential effect of the clause on the contract.

What is claimed is:

1. A system for automatically analyzing and explaining contractual terms and phrases found in legal documents, the system comprising:
one or more processors; and
a memory in communication with the one or more processors and storing instructions that, when executed by the one or more processors, are configured to cause the system to:
receive, from a training system, labeled training data comprising a set of caselaw having labeled legal clauses and corresponding labeled outcomes;
train, using the labeled training data, a recurrent neural network for identify legal clauses and outcomes from a set of caselaw and to generate logical rules for associating the legal clauses to the outcomes;
apply the recurrent neural network to a corpus of caselaw to generate a first set logical rules associated with the corpus of caselaw;
receive, from a computing device, a first legal document comprising one or more legal clauses;
apply the recurrent neural network to the first legal document to generate a second set of logical rules associated with the first legal document;
based on a comparison of the first set of logical rules with the second set of logical rules, determine a relevant case from the corpus of caselaw; and
transmit, to the computing device, data representing the relevant case from the corpus of caselaw.

2. The system of claim 1, wherein the instructions, when executed by the one or more processors, are further configured to cause the system to:
receive, from the computing device, reinforcement feedback based on the relevant case from the corpus of caselaw; and
iteratively re-train the recurrent neural network based on the received reinforcement feedback.

3. The system of claim 1, wherein the instructions, when executed by the one or more processors, are further configured to cause the system to determine, based on the first legal document, a relevant jurisdiction.

4. The system of claim 3, wherein applying the recurrent neural network to a corpus of caselaw to generate a first set logical rules associated with the corpus of caselaw comprises:
generating a jurisdiction specific corpus of caselaw comprising caselaw from the relevant jurisdiction; and
applying the recurrent neural network to the jurisdiction specific corpus of caselaw to generate a first set logical rules associated with the corpus of caselaw.

5. The system of claim 1, wherein transmitting, to the computing device, data representing the relevant case from the corpus of caselaw comprises:
retrieving, from a third part, data representing the relevant case;
annotating the relevant case to highlight one or more legal clauses associated with the first set of logical rules or the second set of logical rules in a first color; and
transmitting the annotated case to the computing device.

6. The system of claim 5, wherein the instructions, when executed by the one or more processors, are further configured to cause the system to annotate the relevant case to highlight one or more outcome associated with the relevant case in a second color, the first color differing from the second color.

7. The system of claim 1, wherein the labeled training data further comprises a set of legal documents associated with the set of caselaw, the set of legal documents having labeled legal clauses and corresponding labeled outcomes.

8. A system for automatically analyzing and explaining contractual terms and phrases found in legal documents, the system comprising:
one or more processors; and
memory, including a recurrent neural network, and in communication with the one or more processors and storing instructions that, when executed by the one or more processors, are configured to cause the system to:
receive a court opinion having a plurality of first legal clauses;
generate, using a segmentation algorithm, a first Markov chain comprising a plurality of first nodes based on the court opinion, the plurality of first nodes each corresponding to one or more of the plurality of first legal clauses of the court opinion;
summarize the plurality of first nodes;
receive a contract document having a plurality of second legal clauses;
generate, using the segmentation algorithm, a second Markov chain comprising a plurality of second nodes based on the contract document, the plurality of second nodes each corresponding to one or more of the plurality of second legal clauses of the contract document;
summarize the plurality of second nodes;
compare each of the summarized plurality of first nodes with each of the summarized plurality of second nodes to identify a difference for each of the plurality of first nodes; and
determine, based on the comparison, whether the difference for each of plurality of first nodes exceeds a predetermined minimum difference threshold.

9. The system of claim 8, wherein comparing each of the summarized plurality of first nodes with each of the summarized plurality of second nodes comprises fuzzy matching the summarized plurality of first nodes with the summarized plurality of second nodes.

10. The system of claim 8, wherein comparing each of the summarized plurality of first nodes with each of the summarized plurality of second nodes to identify a difference for each of the plurality of first nodes comprises determining a Levenshtein distance between the summarized plurality of first nodes and the summarized plurality of second nodes.

11. The system of claim 8, wherein a first first node of plurality of first nodes comprises an arrow connecting to a second first node of the plurality of first nodes.

12. The system of claim 8, wherein the instructions, when executed by the one or more processors, are further configured to cause the system to display an identifier associated with the court opinion when the difference exceeds the predetermined minimum difference threshold.

13. The system of claim 12, wherein the instructions, when executed by the one or more processors, are further configured to cause the system to:
receive, from a computing device, reinforcement feedback based on the court opinion; and
iteratively re-train the recurrent neural network based on the received reinforcement feedback.

14. A system for automatically analyzing and explaining contractual terms and phrases found in legal documents, the system comprising:
one or more processors; and
a memory in communication with the one or more processors and storing instructions that, when executed by the one or more processors, are configured to cause the system to:
receive a plurality of caselaw;
identify one or more legal clause in the plurality of caselaw;
identify one or more outcome in each of the plurality of caselaw;
train a recurrent neural network based on the identified one or more legal clause and the identified outcomes;
receive a corpus of relevant caselaw;
provide the corpus of relevant caselaw to the trained recurrent neural network to generate a set of logical rules;
receive a legal contract;
provide the corpus of relevant caselaw and the legal contract to the trained recurrent neural network to generate a list of matching caselaw comprising one or more case from the corpus of relevant caselaw; and
provide, to a user device, the list of matching caselaw.

15. The system of claim 14, wherein a generating a list of matching case law comprises:
comparing each case of the corpus of relevant caselaw to the set of logical rules to generate a respective corpus score;
comparing the legal contract to the set of logical rules in order to generate a contract score; and
determine, based on a comparison of the corpus scores and the contract scores, a list of matching caselaw comprising a subset of cases of the corpus of relevant caselaw.

16. The system of claim 14, wherein the instructions, when executed by the one or more processors, are further configured to cause the system to:
receive, from the user device, reinforcement feedback based on list of matching caselaw; and
iteratively re-train the recurrent neural network based on the received reinforcement feedback.

17. The system of claim 14, wherein the instructions, when executed by the one or more processors, are further configured to cause the system to determine, based on the legal contract, a relevant jurisdiction.

18. The system of claim 17, wherein providing the corpus of relevant caselaw and the legal contract to the trained recurrent neural network to generate a list of matching caselaw comprising one or more case from the corpus of relevant caselaw; and comprises:
generating a jurisdiction specific corpus of relevant caselaw comprising caselaw from the relevant jurisdiction; and
providing the jurisdiction specific corpus of relevant caselaw and the legal contract to the trained recurrent neural network to generate a list of matching caselaw comprising one or more case from the corpus of relevant caselaw.

19. The system of claim 14, wherein providing, to the user device, the list of matching caselaw comprises:
retrieving, from a third part, data representing the cases included in the list of matching caselaw;
annotating the cases included in the list of matching caselaw to highlight one or more legal clauses associated with the set of logical rules in a first color; and
transmitting the annotated case to the user device.

20. The system of claim 19, wherein the instructions, when executed by the one or more processors, are further configured to cause the system to annotate the cases included in the list of matching caselaw to highlight one or more outcome associated with the cases included in the list of matching caselaw in a second color, the first color differing from the second color.
